(19) United States
(12) Patent Application Publication
(10) Pub. No.: US 2025/0378369 A1
(43) Pub. Date: Dec. 11, 2025

(54) WORKLOAD DISTRIBUTION TO MINIMIZE EXPOSURE RISK FROM VOLATILE ORGANIC COMPOUNDS

(71) Applicant: International Business Machines Corporation, Armonk, NY (US)

(72) Inventors: Rebecca Morones, Berthoud, CO (US); John S. Werner, Fishkill, NY (US); Arkadiy O. Tsfasman, Wappingers Falls, NY (US); Joseph Prisco, Rochester, MN (US)

(21) Appl. No.: 18/737,336

(22) Filed: Jun. 7, 2024

(51) Int. Cl. G06N 20/00

(52) U.S. Cl. CPC G06N 20/00

(57) ABSTRACT

A computer-implemented method to reduce a risk of exposure to volatile organic compounds. The method comprises obtaining a workload for a set of servers in a computing space, wherein the set of servers off-gas a volatile organic compound during operation. The method also includes identifying, for the workload, a set of distributions options to process the workload with the set of servers. The method further includes determining, by a learning model, a volatile organic compound exposure risk for each distribution option. The method includes implementing, based on the determining, a first distribution option of the set of distribution options to process the workload.

### BACKGROUND

The present disclosure relates to workload distribution, and, more specifically, to distributing a workload across a data center to minimize exposure to volatile organic compounds.

Many modern computing systems contain multiple servers, each having one or drawers, where each drawer can contain multiple processing units. These computing systems can form data centers processing large amounts of data. Components used in data centers can emit volatile organic compounds.

### SUMMARY

Disclosed is a computer-implemented method to distribute workloads to reduce a risk of harm from volatile organic compounds. The method comprises obtaining a workload for a set of servers in a computing space, wherein the set of servers off-gas a volatile organic compound during operation. The method also includes identifying, for the workload, a set of distributions options to process the workload with the set of servers. The method further includes determining, by a learning model, a volatile organic compound exposure risk for each distribution option. The method includes implementing, based on the determining, a first distribution option of the set of distribution options to process the workload. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for distributing workloads to reduce a risk of exposure to volatile organic compounds, in accordance with some embodiments of the present disclosure.

FIG. 2 is a block diagram of a computing environment suitable for operation of a workload manager, in accordance with some embodiments of the present disclosure.

FIG. 3 is an example top down view of a computing space, in accordance with some embodiments of the present disclosure.

FIG. 4 is a flow chart of an example method to train/update a clustering model, in accordance with some embodiments of the present disclosure.

FIG. 5 is a flow chart of an example method distribute a workload to reduce risk of exposure to volatile organic compounds, in accordance with some embodiments of the present disclosure.

### DETAILED DESCRIPTION

The present disclosure relates to workload distribution, and, more specifically, to distributing a workload across a data center to minimize exposure to volatile organic compounds.

Many modern computing systems contain multiple servers, each having one or drawers, where each drawer can contain multiple processing units. These computing systems can form data centers processing large amounts of data. Components used in data centers can emit volatile organic compounds.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as distributing a workload to reduce a risk of exposure to volatile organic compounds of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

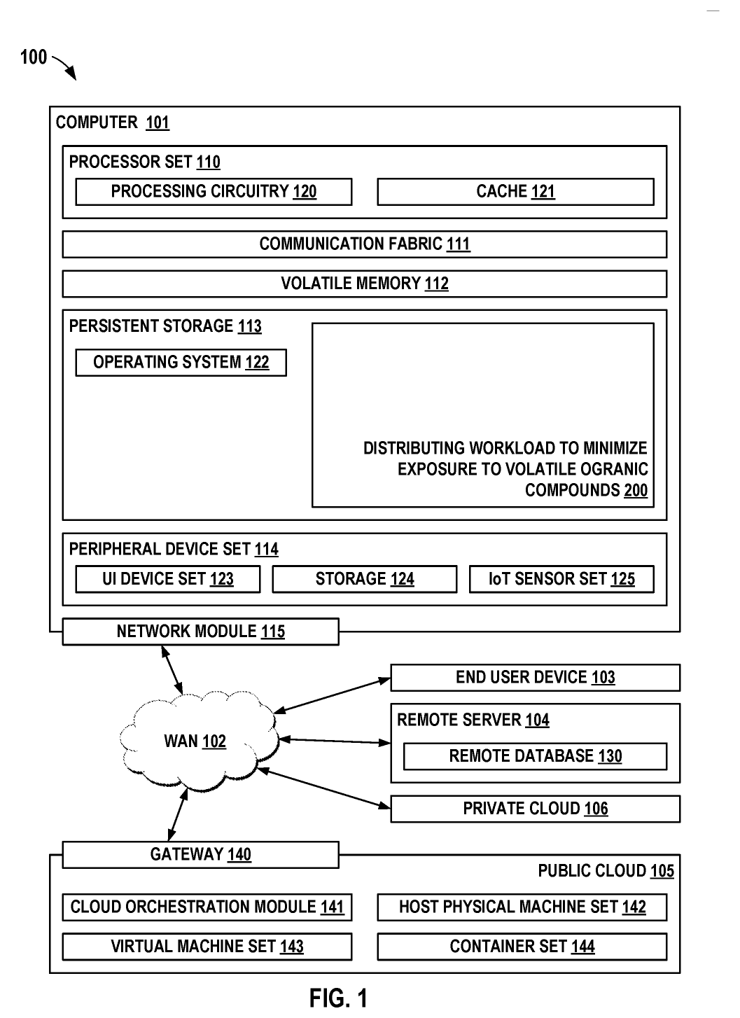

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Volatile Organic Compounds (VOCs) are off gassed/emitted off hardware/electronics. This off gassing can be especially prevalent on new products. As the items are unpacked, installed, and operated the chemicals seep into the air surrounding the items.

These VOCs can cause irritation to the eyes/nose/throat, birth defects, and cancer, and have other harmful effects. This is compounded in a data center environment, which can contain hundreds or thousands of components that contribute to the level of VOC in the air. As the concentration of VOCs increase, the amount of the harmful effects also increases.

In some cases, the amount of off-gassing is related to usage of servers and/or other computing components. For example, running one server at a high intensity may increase the rate of off-gassing. The rate of off-gassing may not necessarily be proportional to processing load alone.

In order to limit concentrations of VOC in a server room or other similar computing space, embodiments of the present disclosure can use VOC off-gassing rates and/or VOC concentrations as a factor in load distribution.

In order to better manage risk of exposure to VOCs in occupied spaces, embodiments of the present disclosure provide for a system and method to distribute workloads based on current and/or predicted VOC concentrations related to off-gassing. The workload distribution can be configured to balance the need for efficient computation while physically lowering an amount of VOC in a human occupied space. The lower levels of VOCs reduce the risk of harm to human workers without sacrificing significant computing efficiency. In some embodiments, workloads can be moved to a server outside of the computing space (e.g., to a second computing space). This will help to limit the rate of off-gassing into a particular space which will maintain VOC levels and associated risks at an acceptable level. In some embodiments, the VOC can be reduced by changing a setting in a mechanical system. This can allow for a higher rate of off gassing while maintaining VOC concentrations at an acceptable level.

Embodiments of the present disclosure includes a workload manager. In some embodiments, the workload manager is configured to monitor one or more of the computing systems, mechanical systems, and atmospheric/environmental conditions. Each of the computing systems, the mechanical systems (referred to generally as the systems), and the environmental conditions generally include and/or are monitored by one or more sensors. The various sensors can collect data related to the operation of the system and the atmospheric/environmental conditions in the area with the off-gassing products (e.g., server room, etc.).

In some embodiments, the data gathered from the sensors used to create one or more vectors. The vectors can include information related to system configuration (e.g., air flow, fan speeds, workload on the various systems, etc.), environmental conditions (e.g., temperature, VOC concentrations, locations of persons), and the like.

In some embodiments, the workload manager uses the vectors to generate and/or update machine learning model (or learning model). The learning model can be a clustering model. The clustering model is used to identify clustered values and use the identified clusters to predict off-gassing rates and/or VOC concentrations. In some embodiments, the clustering model can then be used to predict off-gassing for similar systems running in similar conditions under similar workloads. This prediction can be performed across multiple systems within a data center to determine the best workload balance to minimize overall VOCs within said data center. In some embodiments, the prediction can include VOC concentrations and dispersion based on the current and predicted system characteristics.

In some embodiments, the workload manager can obtain a layout of the computing space. The computing space can be a space that includes a server. In some embodiments, the computing space contain the off gassed VOCs released from the server. In some embodiments, the workload manager can receive and/or identify data related to human presence in the computing space. In some embodiments, computing space and/or the human presence (or prediction of human presence) are factored into the load balancing.

In some embodiments, the workload manager obtains a predicted overall workload. In some embodiments, the workload manager can identify one or more workload distribution options. A distribution option is one permutation for how much and/or which workloads each device/server will be allocated for processing.. In some embodiments, the workload manager predicts the off-gassing and/or VOC concentrations for each of the one or more identified distributions. The workload manager can select one distribution based, at least in part, on the predicted off-gassing and/or VOC concentrations. The selection can be based on minimizing VOCs generally, for a portion of the computing space, to balance efficiency, and/or other factors.

The aforementioned advantages are example advantages, and embodiments exist that can contain all, some, or none of the aforementioned advantages while remaining within the spirit and scope of the present disclosure.

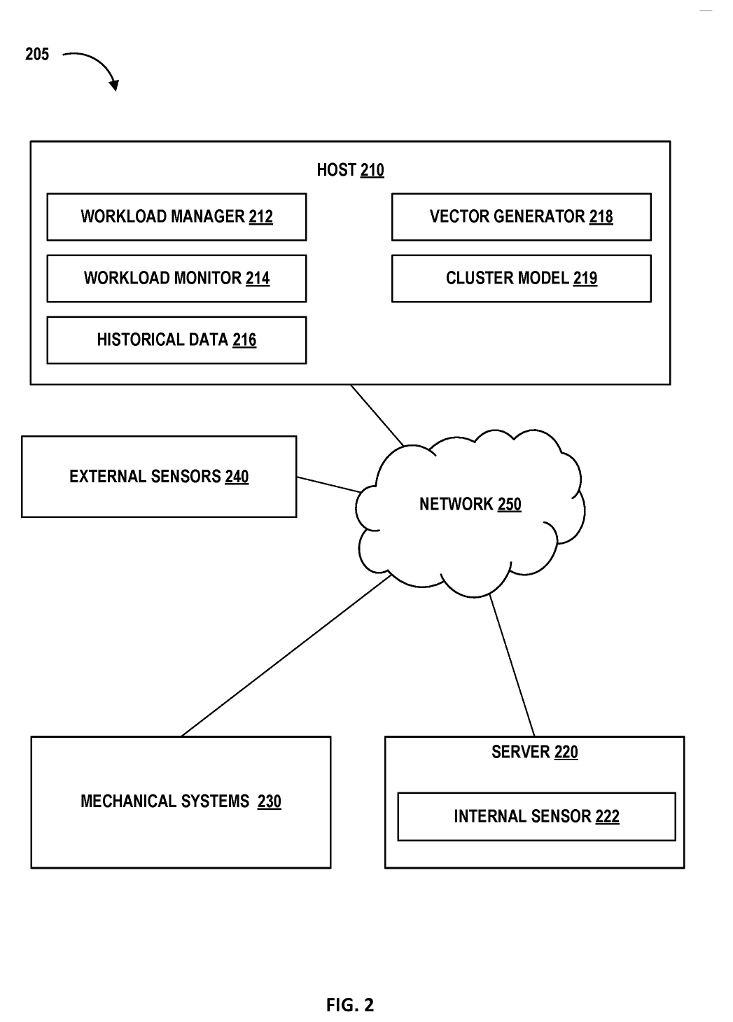

Referring now to various embodiments of the disclosure in more detail, FIG. 2 is a representation of a computing environment 205 that is capable of running workload manager 212 in accordance with one or more embodiments of the present disclosure. Many modifications to the depicted environment may be made by those skilled in the art without departing from the scope of the disclosure.

Computing environment 205 includes host 210, server 220, mechanical systems 230, external sensors 240, network 250. Network 250 can be, for example, a telecommunications network, a local area network (LAN), a wide area network (WAN), such as the Internet, or a combination of the three, and can include wired, wireless, or fiber optic connections. Network 250 may include one or more wired and/or wireless networks that are capable of receiving and transmitting data, voice, and/or video signals, including multimedia signals that include voice, data, and video information. In general, network 250 may be any combination of connections and protocols that will support communications between and among host 210, server 220, mechanical system 230, external sensors 240, and other computing devices (not shown) within computing environment 205. In some embodiments, each of host 210, server 220, mechanical system 230, external sensors 240, and other devices not shown may include one or more a computer system, such as computer 101 of FIG. 1. In some embodiments, network 250 can be consistent with WAN 102 of FIG. 1.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 includes workload manager 212, workload monitor 214, historical data 216, vector generator 218, and cluster model 219. In some embodiments, host 210 and/or any of the subcomponents of host 210 can be incorporated into and/or combined with server 220, mechanical system 230, or external sensors 240. However, they are shown as separate for discussion purposes. In some embodiments, the various subcomponents of host 210 can be combined into one or more components in any combination.

Workload manager 212 can be any combination of hardware and/or software configured to manage and/or monitor workloads being processed by server 220. In some embodiments, workload manager 212 includes workload monitor 214, historical data 216, vector generator 218, and/or cluster model 219. However, these components are shown as separate for discussion purposes.

In some embodiments, workload manager 212 can allocate workload assigned to the computing space to one or more server 220 and/or subcomponents of server 220 (e.g., drawer, processor, etc.). In some embodiments, workload manager 212 can adjust and/or move workload between servers/processors within the computing area. The adjustment can be based on current or predicted VOC concentration level, a VOC risk level, off-gassing rate, upcoming maintenance, environmental conditions, persons in the computing area, and/or other load balancing processes.

Workload monitor 214 can be any combination of hardware and/or software configured to monitor and/or adjust workloads for server 220. In some embodiments, each server, drawer, and/or processor is monitored. In some embodiments, workload monitor 214 monitors temperatures within server 220. The temperatures can be obtained by internal sensor 222.

Historical data 216 can be any combination of data and/or operational information related to server 220, workload manager 212, internal sensor 222, mechanical system 230, and/or external sensors 240. In some embodiments, historical data 216 can be used as training data for cluster model 219. In some embodiments, historical data 216 can include one of more vectors generated by vector generator 218.

Vector generator 218 can be any combination of hardware and/or software configured to generate one or more vectors. In some embodiments, the generated vectors are based on observed/gathered system and environmental data. In some embodiments, the vectors can be based on a location within the computing space. Or said differently, the vectors can include a variable that identifies a location within the computing space. In some embodiments, the vectors can include workload distributions, mechanical system settings, environmental conditions, and the like. In some embodiments, vectors are based on obtained sensor data from internal sensor 222 and/or external sensors 240. The vectors can represent VOC concentrations, system settings, and/or orientation within the computing space.

Cluster model 219 can be any combination of hardware and/or software configured to predict off-gassing and/or VOC concentrations is the computing space. In some embodiments, cluster model 219 includes one or more learning models. The one or more learning models can include a cluster model (or clustering model). A cluster model is a machine learning model that identifies groups of similar records, and groups the records based on the similarities. Clustering models can be considered unsupervised learning because there is no standard by which to compare the results. This allows for groupings of variable and identification of insights and predictions not necessarily available to other types of learning models. In some embodiments, cluster model 219 can cluster the vectors generated by vector generator 218. In some embodiments, the clustering is based on external input.

In some embodiments, cluster model 219 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, cluster model 219 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Server 220 can be any combination of hardware and/or software configured to process data. In some embodiments, server 220 can be a standalone computing device, a management server, a web server, a mobile computing device, or any other electronic device or computing system capable of receiving, sending, and processing data. In other embodiments, server 220 can represent a server computing system utilizing multiple computers as a server system, such as in a cloud computing environment (e.g., cloud environment 105 or 106). In some embodiments, server 220 includes internal sensor 222.

In some embodiments, server 220 can include two or more distinct units. The units can be server drawers, server cards, processors, and/or other similar components. In some embodiments, computing environment 205 includes one or more additional servers in addition to server 220. In some embodiments, server 220 can represent any number of servers in a computing space. Host 210 can be located within or outside of the computing space. In some embodiments, the any number of servers are managed by workload manager 212. In some embodiments, load can be shifted between some and/or all of the servers/subcomponents.

In some embodiments, server 220 is configured to maintain a reliable processing output while balancing several factors including off-gassing rate, VOC concentrations, optimal load processing, unit temperatures, and the like. The workloads can be shifted around as directed by workload manager 212 to change the various outputs/loads/temperatures of server 220.

Internal sensor 222 can be any combination of hardware and/or software configured to gather data within and/or surrounding server 220. Internal sensor 222 can represent any number of sensors and any number of types of sensors. In some embodiments, the type of sensor includes one or more thermometers, thermocouples, heat detectors, moisture detectors, humidity detectors, ambient air detectors, motion detectors, and the like. The number and type of sensors can be configured to gather enough data to identify and monitor temperature and other operating characteristics of various components. In some embodiments, each internal sensor 222 sends the sensor data to workload manager 212 and/or workload monitor 214. Internal sensor 222 can monitor data internal and/or external to server 220.

Mechanical systems 230 can be any combination of hardware and/or software configured to support operation of server 220 in the computing space. In various embodiments, mechanical systems 230 include a cooling system, an HVAC system, a lighting system, and/or personnel safety systems. In some embodiments, one or more of external sensors 240 can be integrated into mechanical systems 230. The integrated sensors can provide data related to the systems. Examples of the data include air flow, VOC concentrations, fans speeds, ambient temperature, and the like.

External sensors 240 can be any combination of hardware and/or software configured to gather data within the computing space. In some embodiments, external sensors 240 have the same or similar properties and/or capabilities as internal sensor 222 except they are not associated with server 220. In some embodiments, external sensors 240 are integrated into mechanical system 230, computing space (e.g., computing space 300), host 210, an undepicted computing device, and/or a self-standing sensor. In some embodiments, each external sensors 240 sends the sensor data to workload manager 212 and/or workload monitor 214.

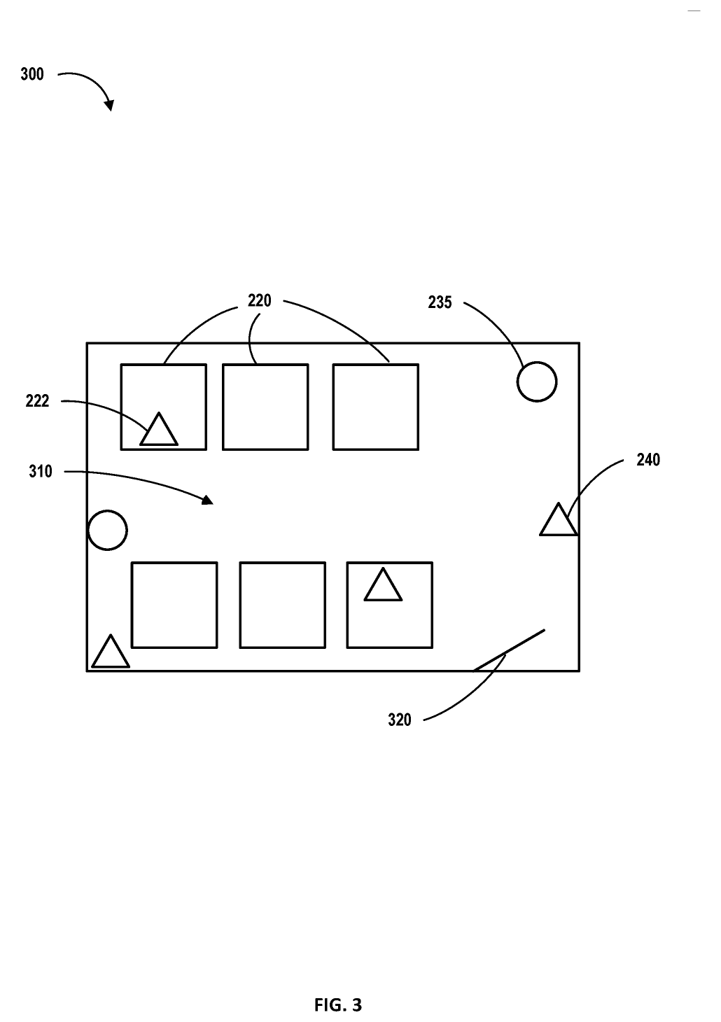

FIG. 3 is an example top-down view of a computing space, computing space 300. Computing space 300 includes server 220, internal sensor 222, external sensors 240, walkway 310, entrance 320, and mechanical system components 235. This embodiment shows six servers, where two of the servers contain an internal sensor 222. There are two external sensors 240, and two mechanical system components 235. Entrance 320 is a way for persons to enter and exit computing space 300. Various embodiments can have more or less of any of the shown components. In some embodiments, location data and/or layout data as shown in computing space 300 can be received by workload manager 212. In some embodiments, one or more of internal sensor 222 and external sensor can determine location data based on the sensor data. In some embodiments, the location data of sensors and other components can be monitored and/or sent to workload manager 212 for use by vector generator 218 and/or clustering model 219.

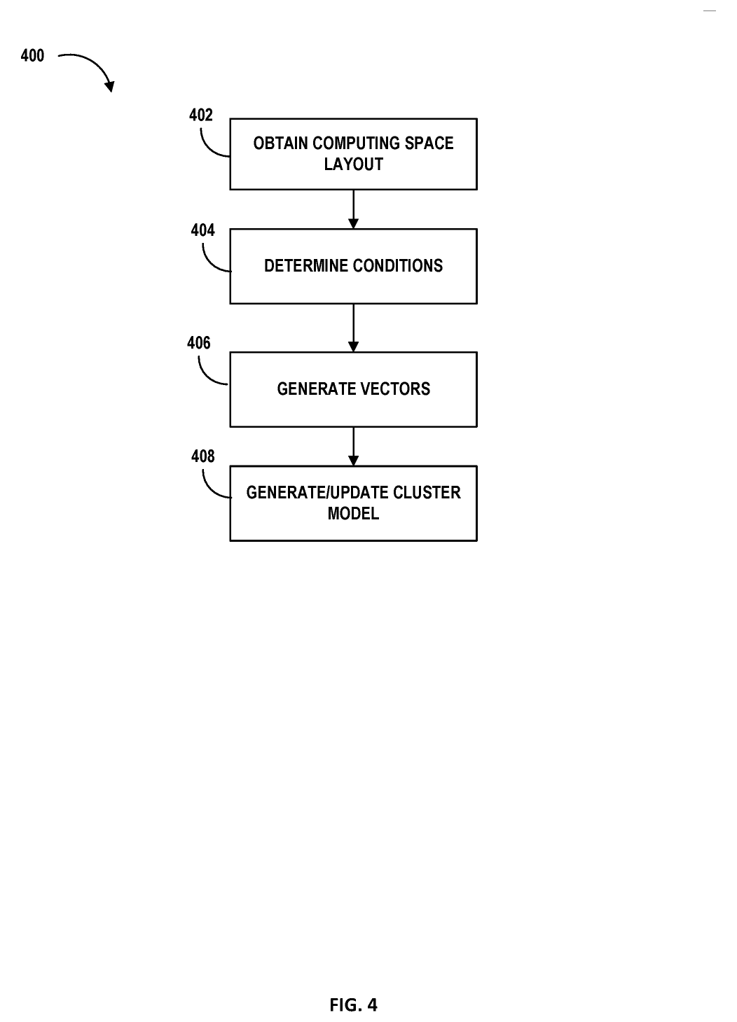

FIG. 4 is a flowchart of an example process 400 for generating and/or updating a cluster model that can be performed in a computing environment (e.g., computing environment 100 and/or computing environment 205). One or more of the advantages and improvements described above for updating a cluster model may be realized by process 400, consistent with various embodiments of the present disclosure.

Process 400 can be implemented by one or more processors, host 210, workload manager 212, workload monitor 214, historical data 216, vector generator 218, cluster model 219, mechanical system 230, server 220, internal sensor 222, external sensors 240, and/or a different combination of hardware and/or software. In various embodiments, the various operations of process 400 are performed by one or more host 210, workload manager 212, workload monitor 214, historical data 216, vector generator 218, cluster model 219, mechanical system 230, server 220, internal sensor 222, and/or external sensors 240. For illustrative purposes, the process 400 will be described as being performed by workload manager 212.

At operation 402, workload manager 212 obtains the layout for a computing space. In some embodiments, the layout defines locations of servers, mechanical components, walkways, sensor locations, and the like. In some embodiments, the layout is received by workload manager 212. In some embodiments, various sensors in the computing space identify the layout.

At operation 404, workload manager 212 determines conditions in the computing space. In some embodiments, the conditions include data related to mechanical systems 230. Data related to mechanical system 230 can be mechanical data. The mechanical data can define air flow, ambient temperature, status (e.g., what is operating/not operation), and VOC concentrations. In some embodiments, the conditions include workload information. The workload can be the current load on server 220 and/or any expected changes in workload. The workload data can be categorized by server, drawer, processor, and/or any other level of categorization. In some embodiments, the conditions can include time. This can be a time of day, day of week, month, and/or any other timing data. This may be beneficial, as the time day or week, or time of year, can be related to changes in workload and subsequently off-gassing.

In some embodiments, the conditions can be location based. For example, computing space can be divided into areas, and the conditions for each area. Each area can be monitored separately and/or combined.

At operation 406, workload manager 212 generates vectors. In some embodiments, the vectors are generated by vector generator 218. In some embodiments, the vectors are based on conditions determined in operation 404. The vectors can store the values of the full set of determined conditions as individual variables and/or combined into a single variable in any combination.

At operation 408, workload manager 212 generates a learning model. In some embodiments, the learning model is cluster model 219. In some embodiments, the learning model utilizes a clustering technique. In some embodiments, the learning model is generated based on vectors generated in operation 406. In some embodiments, operation 308 includes updating cluster model 219. Method 400 can be repeated at predefined intervals. The intervals can be based on time, system changes, and/or environmental changes. In some embodiments, the learning model is configured to identify changes over time. As new vectors are generated, the learning model is updated to identify transients in workload and corresponding changes in VOC concentrations.

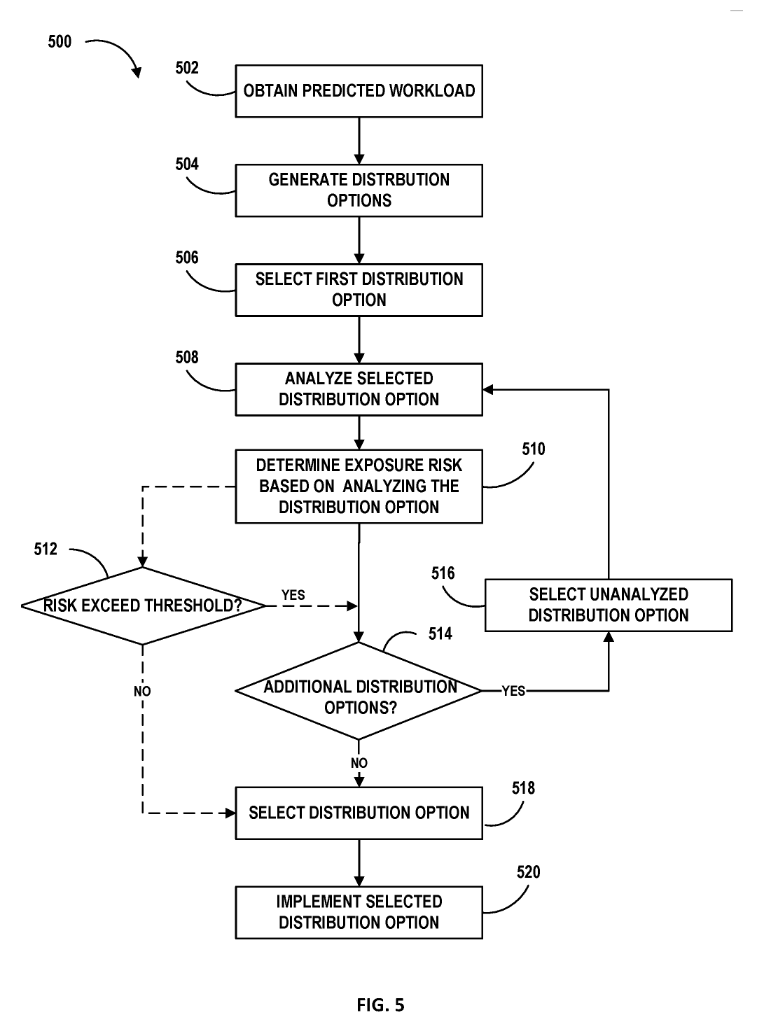

FIG. 5 is a flowchart of an example process 500 for distributing a workload based on off-gassing of components that can be performed in a computing environment (e.g., computing environment 100 and/or computing environment 205). One or more of the advantages and improvements described above for predicting VOC concentrations may be realized by process 500, consistent with various embodiments of the present disclosure.

Process 500 can be implemented by one or more processors, host 210, workload manager 212, workload monitor 214, historical data 216, vector generator 218, cluster model 219, mechanical system 230, server 220, internal sensor 222, external sensors 240, and/or a different combination of hardware and/or software. In various embodiments, the various operations of process 400 are performed by one or more host 210, workload manager 212, workload monitor 214, historical data 216, vector generator 218, cluster model 219, mechanical system 230, server 220, internal sensor 222, and/or external sensors 240. For illustrative purposes, the process 500 will be described as being performed by workload manager 212.

At operation 502, workload manager 212 obtains a predicted workload. In some embodiments, the predicted workload includes a current monitored workload on server 220 and/or data on how the workload can change. This can include known and/or expected load changes (e.g., incoming batch workload, etc.) The predicted workload can be based on analytics to predict a future workload relative to current workloads. In some embodiments, the predicted workload is predefined and received from a user, sponsor, or otherwise input into workload manager 212.

At operation 504 workload manager 212 generates distribution options. In some embodiments, a distribution option is a manner in which a workload may be spread across server 220 and/or the subcomponents/processors in the computing area. In some embodiments, the number of distribution options generated is predetermined. In some embodiments, the number of generated distribution options is based on additional system characteristics. For example, one characteristic can be that the load on each processor/server must be within a percentage of other processors/servers. In another example, the workload of any one processor/server cannot deviate from the average of all other servers by greater than a threshold percent. As a third example, all processors must have met at least a minimum threshold of workload. As a fourth example, each workload must be within a predetermined number of standard deviations of the mean. In some embodiments, the distribution options that would maintain overall system efficiency above a threshold system efficiency can be generated. The efficiency can be based on a percentage of design load. In some embodiments, the efficiency can be based on externally measured characteristics such as core temperature, and/or cooling air flow. In some embodiments, the characteristics to manage the number of distribution options can be stored in historical data 216.

At operation 506, workload manager 212 selects a first distribution option. In some embodiments, the first distribution option is included in the generated distribution options. In some embodiments, the first distribution option is based on a predicted efficiency of workload distribution. For example, the distribution option with the highest predicted efficiency can be the first distribution option. In some embodiments, any of the generated distribution options can be the first distribution option.

At operation 508, workload manager 212 analyzes the selected distribution option. In some embodiments, the analysis of the distribution option comprises predicting VOC concentration levels for the selected distribution option. In some embodiments, the prediction can include off-gassing amount of VOC and/or an off gassing rate of VOCs. In some embodiments, the prediction is made by clustering model 219. In some embodiments, the prediction includes obtaining the set of current conditions. The set of current conditions can be data based on a current input to the various sensors. This can be similar to operation 404 of method 400. The current conditions and workload can be used to predict an amount of off-gassing and/or a resulting VOC concentration. The prediction can be for a particular server, for the computing space as a whole, and/or for a portion of the computing space.

At operation 510, workload manager 212 determines an exposure risk based on the analyzing the distribution option. In some embodiments, the exposure risk is based on the predicted VOC concentrations and/or VOC off gassing rates. In some embodiments, the exposure risk is based on whether persons are within or will be within the computing space. For example, if motion detection is identifying persons in the area, the exposure risk may be relatively higher than when no persons are in the area. In some embodiments, the exposure risk is based on analyzing a current set of inputs. In some embodiments, the exposure risk is based on the model output of predicted VOC concentrations in the computing space. In some embodiments, after completion of operation 510, workload manager 212 proceeds to operation 514. The action of operation 512 can be bypassed in total and/or moved to a different portion of method 500.

At operation 512, workload manager 212 determines if the exposure risk exceeds a risk threshold. In some embodiments, the threshold is a preterminal VOC concentration level. If the concentration exceeds the risk threshold concentration level, then the exposure risk exceeds the exposure threshold. If it is determined that the exposure risk exceeds the threshold (512:YES), then workload manager 212 proceeds to operation 514. If it is determined that the exposure risk does not exceed the threshold (512:NO), then workload manager 212 proceeds to operation 518.

At operation 514, workload manager 212 determines if there are additional distribution options to analyze. In some embodiments, there are additional distribution options to analyze if a distribution option generated in operation 504 does not have a predicted VOC concentration (e.g., if operation 508 was not performed on all generated distribution options). In some embodiments, all of the distribution options are analyzed In some embodiments, the determination that there are no additional distribution options to analyze is based on analyzing a predetermined number of distribution options. If it is determined that additional distribution options need to be analyzed (514:YES), then workload manager 212 proceeds to operation 516. If it is determined there are not additional distribution options to analyze (514:NO), then workload manager 212 proceeds to operation 518.

At operation 516, workload manager 212 selects a next unanalyzed distribution option. An unanalyzed distribution option is any distribution option where workload manager 212 has not predicted VOC concentrations for that distribution option. In some embodiments, the next unpredicted distribution option can be any distribution option of the distribution options that were generated in operation 504 that is not predicted.

At operation 518, workload manager 212 selects one analyzed distribution option. In some embodiments, the selection is based on a lowest predicted VOC concentration. In some embodiments, the selection is based on the selected analyzed distribution option having a lowest exposure risk. In some embodiments, the selection is based on an efficiency of the distribution option. For example, the distribution option that has the highest efficiency with an exposure risk below a threshold can be the selected distribution option.

In some embodiments, operation 512 is performed after operation 518. The determined exposure risk for the selected distribution option is compared risk threshold. If the risk is below the threshold, then workload manager 212 proceeds to operation 520. If the risk is above the threshold, then workload manager 212 returns to operation 518 to select a different distribution option.

At operation 520, workload manager 212 implements the selected distribution option. In some embodiments, the implementation includes distributing workloads to the various components of server 220 such that the actual load of the components of server 220 matches the selected distribution option. This can include adding and/or removing workloads from one processor/device to a different processor device. In some embodiments, if all distribution options have a risk above the risk threshold, workload manager 212 can alter the workload and/or the predicted workload. The alteration can include reducing the workload. The reduction can be to move workload to a processing location outside of the computing room. Thus, any off-gassing would not occur in the computing room. Additionally, the reception can include slowing the processing speed. This can reduce the amount of off-gassing to maintain the risk levels at an acceptable level. In some embodiments, operation 520 includes processing the workload in accordance with the selected and implemented distribution option.

Embodiments of the present disclosure can identify a way to distribute a workload across one or more servers while minimizing a risk to persons related to VOC exposure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a workload for a set of servers in a computing space, wherein the set of servers off-gas a volatile organic compound (VOC) during operation;
identifying, for the workload, a set of distributions options to process the workload with the set of servers;
determining, by a learning model, a VOC exposure risk for each distribution option; and
implementing, based on the determining, a first distribution option of the set of distribution options to process the workload.

2. The computer-implemented method of claim 1, wherein the learning model is a clustering model, the method further comprising:
training the clustering model to determine the VOC exposure risk for a distribution option.

3. The computer-implemented method of claim 2, further comprising:
obtaining a layout of the computing space;
determining a set of conditions of the computing space; and
generating vectors to represent the set of conditions, wherein the training the clustering model is based on the vectors.

4. The computer-implemented method of claim 3, wherein the determining the VOC exposure risk further comprises:
analyzing an input of a current set of conditions; and
obtaining an output that includes a predicted VOC concentration level in the computing space.

5. The computer-implemented method of claim 3, wherein the set of conditions of the computing space comprises workload distribution data, environmental data, and VOC concentrations.

6. The computer-implemented method of claim 3, wherein the set of conditions is recorded at a predetermined interval, and the set of conditions is stored.

7. The computer-implemented method of claim 6, further comprising:
updating the cluster model based on the generated vectors.

8. The computer-implemented method of claim 1, further comprising:
selecting the first distribution option, wherein the selecting the first distribution option is based on a first exposure risk for the first distribution option being below a risk threshold.

9. The computer-implemented method of claim 8, further comprising:
selecting the first distribution option, wherein the selecting the first distribution option is based on the first distribution option having a lowest determined VOC exposure risk of the set of distribution options.

10. A system comprising:
a processor; and
a computer-readable storage medium communicatively coupled to the processor and storing program instructions which, when executed by the processor, are configured to cause the processor to:
obtain a workload for a set of servers in a computing space, wherein the set of servers off-gas a volatile organic compound (VOC) during operation;
identify, for the workload, a set of distributions options to process the workload with the set of servers;
determine, by a learning model, a VOC exposure risk for each distribution option; and
implement, based on the determining, a first distribution option of the set of distribution options to process the workload.

11. The system of claim 10, wherein the learning model is a clustering model, and the program instruction are further configured to cause the processor to:
train the clustering model to determine the VOC exposure risk for a distribution option.

12. The system of claim 11, wherein the program instruction are further configured to cause the processor to:
obtain a layout of the computing space;
determine a set of conditions of the computing space; and
generate vectors to represent the set of conditions, wherein the training the clustering model is based on the vectors.

13. The system of claim 12, wherein the determination of the VOC exposure risk further comprises:
analyzing an input of a current set of conditions; and
obtaining an output that includes a predicted VOC concentration level in the computing space.

14. The system of claim 10, wherein the program instruction are further configured to cause the processor to:
select the first distribution option, wherein the selection of the first distribution option is based on a first exposure risk for the first distribution option being below a risk threshold.

15. A computer program product, the computer program product comprising a computer readable storage medium having program instructions embodied therewith, the program instructions executable by a processing unit to cause the processing unit to:
obtain a workload for a set of servers in a computing space, wherein the set of servers off-gas a volatile organic compound (VOC) during operation;
identify, for the workload, a set of distributions options to process the workload with the set of servers;
determine, by a learning model, a VOC exposure risk for each distribution option; and
implement, based on the determining, a first distribution option of the set of distribution options to process the workload.

16. The computer program product of claim 15, wherein the learning model is a clustering model, and the program instruction are further configured to cause the processing unit to:
train the clustering model to determine the VOC exposure risk for a distribution option.

17. The computer program product of claim 16, wherein the program instruction are further configured to cause the processing unit to:
obtain a layout of the computing space;
determine a set of conditions of the computing space; and
generate vectors to represent the set of conditions, wherein the training the clustering model is based on the vectors.

18. The computer program product of claim 17, wherein the determining of the VOC exposure risk further comprises:
analyzing an input of a current set of conditions; and
obtaining an output that includes a predicted VOC concentration level in the computing space.

19. The computer program product of claim 18, wherein the set of conditions of the computing space comprises workload distribution data, environmental data, and VOC concentrations.

20. The computer program product of claim 15, wherein the program instruction are further configured to cause the processing unit to:
select the first distribution option, wherein the selection of the first distribution option is based on a first exposure risk for the first distribution option being below a risk threshold.
